(19) United States
(12) Patent Application Publication
(10) Pub. No.: US 2007/0019571 A1
(43) Pub. Date: Jan. 25, 2007

(54) Apparatus and method for audio communications

(76) Inventor: Scott Stogel, Westport, CT (US)

Correspondence Address: Mark E. Ungerman;FULBRIGHT & JAWORSKI L.L.P., 801 Pennsylvania Avenue, N.W., Washington, DC, 20004-2623, US

(21) Appl. No.: 11/205,016

(22) Filed: Aug. 17, 2005

Related U.S. Application Data
(60) Provisional application No. 60/606,142, filed on Sep. 1, 2004.

(51) Int. Cl. H04L 12/16

(52) U.S. Cl. 370/260

(57) ABSTRACT

An audio communication device is provided suitable for conducting audio communication including paired half duplex audio communications. The device includes a processor and associated memory with a codec connected to the processor. A TCP/IP operating system may be running on the processor. At least one audio transducer and audio circuit may be connected to the codec and/or processor. The device may establish a connection with a remote device on power-up or reset and is responsive to a trigger to transmit data representative of an audio input to a remote device. The intercom device or audio terminal may also receive and convert data from a remote device to an audio output. Advantageously, the audio terminal device may have a TCP/IP client/server connection with the remote device.

### BACKGROUND

1. Field of the Invention

The invention relates to an intercom or audio communication system and more particularly to units connected together using an Internet Protocol connection. The invention relates to a client listener pair, each with IP addresses. The intercom system can be paired and/or half duplex to avoid problems attendant to latency and allow the speaker to work (reversed) as a microphone.

2. Description of the Related Technology

Audio communication over Ethernet and Internet connections are known. They are implemented in voIP telephony equipment, music distribution and remote audio monitoring. Analog intercoms connected by copper wiring are also known and in general use in apartments, business offices and industrial environments.

### SUMMARY OF THE INVENTION

The invention described herein is an apparatus and a method of two way audio communication over Internet Protocol where the connection, once established, provides communications at each end. The apparatus may contain a processor with associated memory, a TCP/IP protocol stack, a codec and an audio transducer. The invention may provide methods for multiple means of automatic network connection and disconnection, digital audio conversion, control and synchronization of both units, management of the microphone and speaker audio switching and an internal network transmitted command language.

The apparatus, referred to herein as an ‘Intercom’ or audio communication terminal may have a known TCP/IP address and may use a connection protocol (in a ‘Client’ mode) to connect to another device, assigned as a TCP/IP listener (in ‘Server’ mode). According to an advantageous feature, both units in a pair of audio communication terminals may contain a switch for TALK and may provide instant Push-To-Talk (PTT) communication anywhere in the world.

The simplicity of the method allows the invention to be low cost and easy to configure. An intercom, according to the invention does not require SIP (Session Initialed Protocol), H.323 gateways, but rather, may use flexible paired connection techniques. This allows a system that may be designed for easy interconnection, and communication without handsets or telephone style dialing keypads, utilizing Microcontroller processors, thus avoiding the expense of Digital Signal Processors or 16 and 32 bit processor. Cost saving features by such a system may be significant and user operation is simplified via ‘walkie-talkie’ style communication, providing a mechanism for audio from the caller to be heard instantly at the remote end, without ringing or called user intervention.

Additionally, by providing a half-duplex client-listener connection, potential delay between talkers (latency) creating a discomfort during conversation may be avoided, a single speaker may be used as a bi-directional transducer, saving the cost and housing for a separate microphone and acoustic feedback is not problematic as in full duplex designs.

In the event that a Listener device becomes unavailable for connection, the client device stations may advantageously seek and connect to a one of any number of programmed ‘fail-forward’ listeners. The address of these fail-forward IP addresses may be stored in local memory.

A system, according to the invention may optionally exhibit the following features and/or advantages.
Designed to connect to networks, taking advantage of modem infrastructure expansions using CAT5/6 network cabling seen in recent years.
Interconnects in various flexible, implementations, scalable from 1 pair to thousands of units
Expands seamlessly over LAN to Wireless and Fiber and Internet (WAN) networks, providing vast new voice communication means including arrays of security monitoring stations and desktop to desktop intercoms, connected worldwide
Simple method of communication providing single button communications using Push-To-Talk (PTT) technology shown to be widely popular in cellular communication.
Fabricated to be suitable for incorporation in industrial, business, military and home installations
Half Duplex IP audio operation includes benefits to users such as; avoiding real-time audio latency issues, conserving network bandwidth, providing ‘immediate’ dialog via PTT operation and providing a means to use a single speaker element bi-directionally
Unique switching design provides means to operating seamlessly in both PTT and hands-free mode
Reduces cost and complexity of developing voIP phone systems, based on DSP or ARM processors that rely on SIP or H.323 support to administer connection states.
Provides a feature rich Audio over IP solution whereby proprietary voIP codecs and full-duplex methods attached to royalties for Intellectual Properties are not required, further saving costs.
Provides for optional contact closures, such as door access, or sensors inputs expanding usefulness
Provides optional connection forwarding to reconnect to an available listener
Provides optional remote microphone monitoring, with privacy control
Provides optional capability to play announcements, including UDP broadcasts containing audio and programming information
Provides optional capability for remote update via flash memory from a central server
Provides methods and switches for hands-free operation, including full-duplex audio modes
Provides a means for selective address designators for paging in intercom station groups
Be housed in various forms, such as a wall panel or telephone type device
Accommodate enhanced interfaces that may contain keypads and graphical displays
Provide actuators to terminate a connection
Provide actuators achieve alternate paired connections to another intercom in a plurality of intercoms

### BRIEF DESCRIPTION OF THE DRAWINGS

FIG. 1 shows a schematic interconnection of two devices, directly connected together on power up.

FIG. 2 shows plurality of similar hardware, all in standby.

FIG. 3 shows plurality of similar hardware devices, each in client mode, all seeking and connecting to a single server, running communications management software to handle multiple client connections.

FIG. 4 shows an embodiment of an intercom device according to the invention.

FIG. 5 shows the hardware according to FIG. 2, after a paired connection.

FIG. 6 shows a schematic of an embodiment of the invention.

FIG. 7A shows a half duplex transmitter and receiver comprising a microphone and speaker

FIG. 7B shows a half duplex transmitter and receiver comprising speaker

FIG. 8 shows a flowchart of a method according to an embodiment of the invention.

FIG. 9 shows a flowchart of a method according to an embodiment of the invention.

FIG. 10 shows a flowchart of a method according to an embodiment of the invention.

### DETAILED DESCRIPTION OF THE PREFERRED EMBODIMENT

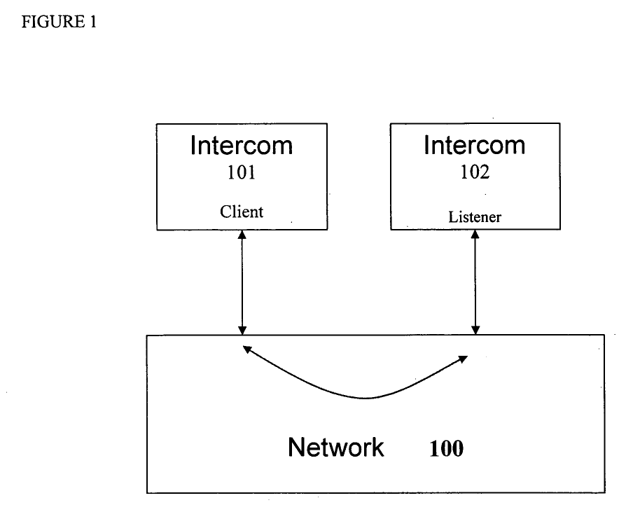

FIGS. 1-3 and 5 show IP enabled hardware, each with their own IP address, static or assigned by DHCP connected by various mechanisms.

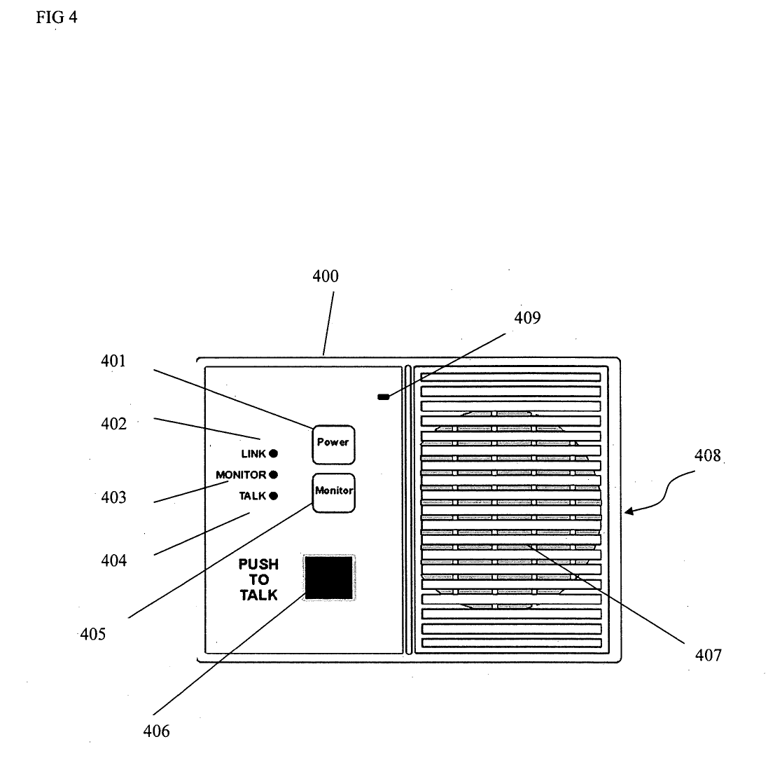

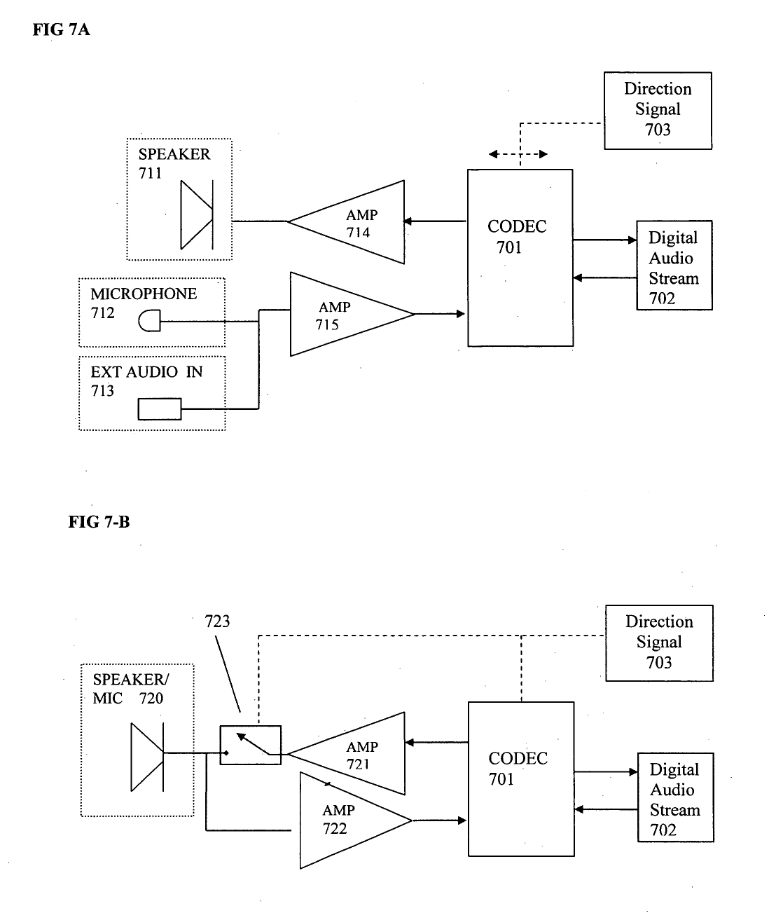

In a described embodiment the apparatus may be entirely housed in a single Intercom enclosure (400). The device may have a power input (not shown in FIG. 4) and a network connection, such as an RJ45 10/100 Ethernet Jack (also not illustrated). These might enter the enclosure via rear or side connection jacks. The Intercom device shown in FIG. 4 contains a Power Switch (401) and Indicators (402-404), switches and audio transducers. The link indicator (402) may display the condition of physical network connection, independent of the protocol or communication in progress. The Monitor indicator (403) may provide a local privacy indication displaying the state of the intercoms as transmit mode. The talk indicator 404 may be illuminated when audio transmission in progress. The speaker (407) and microphone (409) may be used as transducers for playing received audio and transmitting voice. In alternate embodiments the microphone may be eliminated in favor of the two mode transducer circuitry shown in FIG. 7B. The Talk Button shown (406) may provide a local PTT (Push To Talk) signal to enable transmission of audio in the form of a digital trigger signal to the processor. Advantageously, a handsfree actuator key may be included to engage automatic control of the Talk trigger, based on audio sampling techniques used in hands-free speakerphones.

The monitor button (405) may be used to signal the processor to create a command to be sent to the remote intercom. The monitor command code would signal the remote intercom to engage it's transmitting mode, sending audio back to the local intercom. In this manner a monitor button could be used to ‘listen in’ to a remote location, effectively as a traditional baby monitor might be able to listen in to a remote location. This system of listening in also provides for an automatic hands free conversation at the distant intercom, as the management of the remote talk trigger is handled from the originator's intercom when used in reverse sequences of the originators talk button actions.

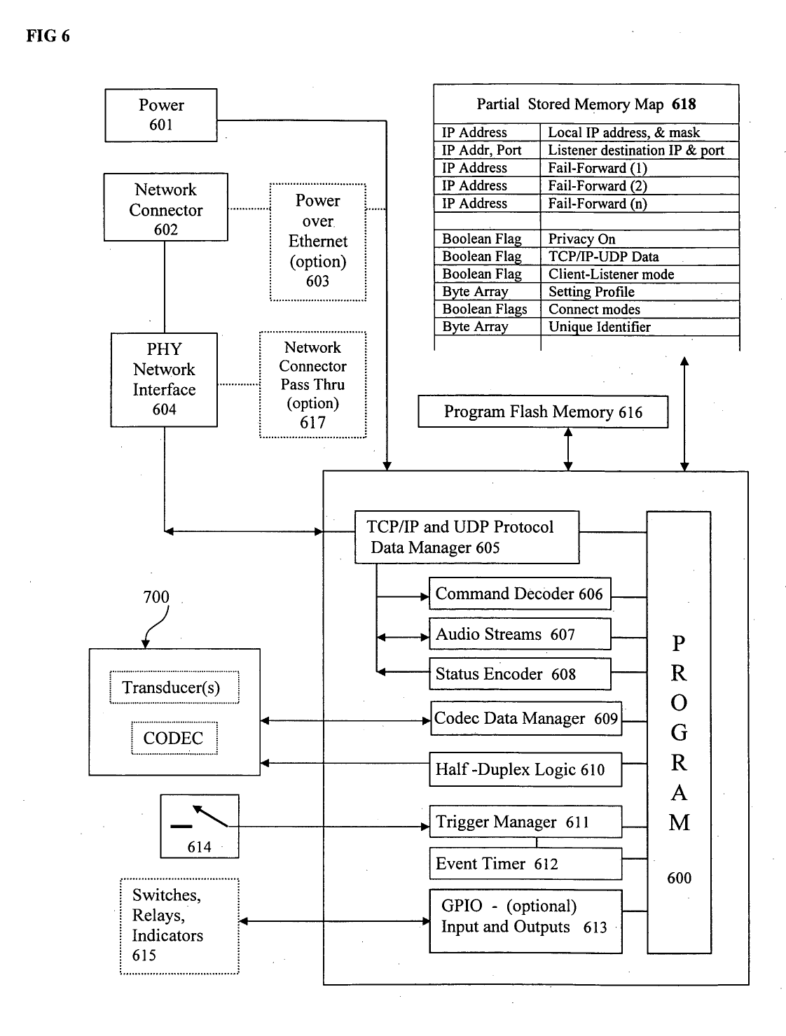

The enclosure houses the electronic assembly schematically shown in FIG. 6. Incorporating power management, a network interface, a processor, a Codec, a transducer and optional external controls and indicators Network and Power (601-604).

The network connection (602) described may be standard design for clarity, a RJ45 housing with 10/100 magnetic isolation, connected to a PHY interface IC, such as a RealTek 8201BL (604). Other network connections (not shown) may include higher speed networks, wireless 802.11b, Bluetooth, Optical and Power-Line solutions that all capable of transport data using TCP/IP protocol. A Power connection (601) is shown to provide the 3.3 and/or 5.0 volt DC power. Optional methods for Power over Ethernet (PoE) (603) may be employed to deliver required power, without 601, when incorporated with the Network wiring connections (602). Optional network connections (617) such as RJ45 connectors may be incorporated via attachment to existing of PHY interface ICs to extend the network path to additional devices.

The electronics for implementation do not require extensive DSP processing power. In the example shown a TCP/IP Protocol Stack ASSP and processor (600) such as Atmel 8052 with 64KB Flash Memory and 2 K of RAM can be employed. Twenty Five (25) MHZ devices have been chosen and provide sufficient processing power.

The programming of the processor 600 may contain algorithms to handle basic functions:

TCP/IP and UDP data manager (605) may be used to store TCP/IP connection states and manage packet for reception and transmission in the form of a TCP/IP “Stack”. A key element used in this management is the connection mode attempted. The intercom may be configured as TCP/IP Client or TCP/IP Listener, both of which are required to make a valid “Connection” whereby usable device operation data and digital audio may be transferred. The manager's connection (client or listener) mode may be set by a logic flag in memory (618), shown as ‘client-listener’ mode. Three connection scenarios are shown in FIGS. 1, 2, 3 that utilize the client-listener connection methods.

Data from the TCP/IP and UDP data manager 605 is transferred via a method that includes commands and data certain functions are listed in Table 1. Other functions are possible. Audio data may be incorporated between or contain commands when transferred serially in real time. Video or other data may also be transferred in versions envisioned.

The Command Decoder (606) parses incoming data for remote instructions that may include commands to raise or lower a volume in the Codec (609), open a door relay (613) or remotely control the Trigger Manager (611), effectively turning on the local microphone from a remote location by a network signal. It may also hold cryptographic keys, flash memory programming codes and subsequent data stream information that may be used for remote servicing and data security. Advantageously the arriving data may be sent as a broadcast, and received in a form such as UDP data packet, and may contain command information, memory programming information and/or an audio packet stream. In such cases the decoder (606) may manage the data by detection, setting or the memory flag TCP/IP -UDP (618) and timing the decoding of incoming UDP packets decoding as needed. The detection of UDP and TCP/IP modes may be a function of the decoder and network stack within the TCP/IP and UDP data (605). The UDP broadcast technique may be used to exchange data information prior to an actual client-listener paired connection, and is particularly useful for system setup and configuration.

The Command Encoder (608) may create formatted code commands that, when transmitted, send signaling information to the remote network devices. This can be a signal to open a door relay or a signal indicating the start or end of a local audio transmission or status conditions.

The Audio Stream section (607) manages software based conversion techniques that may include technologies such as uLaw or GSM compression, tone generation, voice activated transmission control (VOX level detection) and encryption/decoding security algorithms applied to the audio stream itself.

The Half Duplex Logic controls (610) may be implemented on the processor. The Half Duplex Logic control may be configured to allow 2-way communication via PTT (Push-To-Talk), wherein each party in a paired communication may either listen or speak at alternating intervals. The process provides simple connection mechanism such as (Push to Talk) or hands-free (speakerphone) style communication while maximizing the available bandwidth on the network by having a single audio stream transferring at any point in time (to or from the apparatus). This operational method also prevents acoustic feedback eliminating the need for DSP based echo-canceling processors.

To control the Half Duplex Logic from the enclosure a TALK switch (614) is shown. Depression of the switch is used to transmit an audio steam to the remote intercom.

Advantageously the Half Duplex logic (610) may be controlled by the Trigger Manager (611); enabling a remote command from (606) to be used to control the state of the Trigger. In addition the Half Duplex logic may be further controlled by automatic time-out section (612) to return the trigger to the idle mode after a period of time, such as an “operator idle” or inactivity period.

Control logic controls the direction and transmission/reception of audio streams are shown in FIGS. 7A and 7B.

The logic management may optionally be used to tell the Audio Stream Manager (607) to generate a beep at the end of the audio transmission, effectively informing the remote human operator the audio channel is free and they may reply by voice. This is an operational mode, using beeps, that is commonly used in Cellular communications (such a Nextel Push To Talk™ walkie-talkie). Audio streams may also be coded to provide operations such as audio paging and announcements.

TABLE 1
Sample Packet Stream

| | | | | |
|---|---|---|---|---|
| | <value> | | | |
| cmd-code | Optional | cmd-code | Audio stream PCM | cmd-code |

Sample Command Codes

| Name | Value | Description |
|---|---|---|
| cmd_PICFLASH | 10 | Program flash memory |
| cmd_TXcode_0 | 11 | Tell intercom to play audio |
| cmd_TXcode_1 | 12 | Intercom play off |
| cmd_NVWRITE | 13 | Write a value to the intercom profile |
| cmd_PING | 14 | Ping the intercom, |
| cmd_MONON | 15 | Set intercom to remote monitor mode |
| cmd MONOFF | 16 | Clear intercom to remote monitor mode |
| cmd_SET_SW_CFG | 17 | Send switch config byte set port config |
| cmd_SET_LED_STATE | 18 | Set led state, byte |
| cmd_SET_TONE | 19 | Generate TONE FREQ, MSB (*255) |
| cmd_FRIENDLYNAME | 21 | Set is the Friendly Name Text |
| cmd_DOOR_OPEN | 22 | Open the door relay |

Status Information

| | | |
|---|---|---|
| cmd_CONNECT_SERVER_MODE | 73 | Connected in Server Mode |
| cmd_CONNECT_CLIENT_MODE | 74 | Connected in Client Mode |
| cmd_CONNECT_FAIL | 75 | Not connected |
| cmd_DHCP_FAIL | 76 | Connect to the DHCP host |
| cmd_SERVER_LISTENING | 77 | Listening for a connection |
| cmd_DOORISOPEN | 79 | ACK door opened |
| cmd_DOORISCLOSED | 81 | ACK door closed |
| cmd_MICISON | 82 | Intercom microphone is on |
| cmd_MICISOFF | 83 | Intercom microphone is off |
| cmd_GET_LED_STATE | 84 | Send led states |
| cmd_READ_SW_CFG | 85 | Send switch states |
| cmd_READ_ST_CFG | 86 | Send status byte set |
| cmd_MICON | 87 | Primary intercom microphone key depressed |
| cmd_MICOFF | 88 | Primary intercom microphone key un-pressed |
| cmd_SEND_MAC_ADDR | 89 | Send the MAC address |
| cmd_FRIENDLYNAME | 90 | Send the Friendly Name |

A General Purpose Input-Output (GPIO) control (613) may be used to manage hardware lines (Ports on the Processor) that may control relays, sensors or indicators, to facilitate sharing the TCP/IP data stream for real world events such as the control and sensing of relays, LED indicators, actuators, detectors and digital states of external signals for any purpose, including the intercom user interface itself interface and external security and access control.

The digitally controlled transducer is shown in the design, FIG. 7A and 7B, as a mechanism for transmitting and delivering audio compatible with the half duplex operation of the intercom. As noted, half duplex operation is controlled by the half duplex logic in the processor which may set a digital direction state. The direction state may be manifested by a direction signal (703) shown in FIG. 7.

Audio may be converted to digital signals by Codec (701), or discreet implementations of DAC (Digital to Analog) or ADC (Analog to Digital) converters. The Codec then presents a purely digital data stream (702) to the Processor.

FIG. 7A shows a Microphone (712), for example a Panasonic WM54 and Speaker (711), for example as in CUI-GA0666 with power amplifier (714) (ex: National Semi LM386) and Microphone Pre-Amp (such as AD SS21671 combined to interface to a Codec such as Winbond 681511. In addition, the system may be provided with an external input (713). Such blocks as shown are also available in either more discreet or more highly integrated implementations, all used to convert Analog and Digital signals. The common elements are the use of a separate and discreet speaker and microphone. The Direction Signal (703) is used to control the Codec switching to either transmit or receive audio, exclusively, to at least avoid feedback or optimize bandwidth.

FIG. 7B shows an alternate transducer arrangement, sharing send and receive functions in a single audio element, speaker/microphone (720). Existing and new intercom interface panels are available in panels housing only a passive speaker and ‘talk’ button. Such a panel may have a steel vandal-proof plate, a weatherproof speaker and large Call/Talk Signaling button. In FIG. 7B the intercom is shown with a mechanism to connect to such a panel, external from the self contained enclosure shown (400). In this example the direction (703) signal controls the audio stream path and also opens the load of the amplifiers output path 721 during the periods of “Talking” to facilitate using the speaker as a microphone element. This may be an electronic switch as shown (723), a hybrid network design, or mode that might otherwise be accomplished by digitally setting the amplifier shutdown pin. The output of the speaker/microphone may be connected to an amplifier (722) with an output connected to the CODEC 701. A digital audio stream (702) runs between the CODEC and the processor.

Alternate transducers available, but not shown, may include ‘bullhorn’ speakers and parabolic microphones, or a microphone and ear element combined in telephone style handset. Additionally audio signals connected tot the Codec maybe generated from external input signals such as recorded security and information audio content, and real-time sources such as Internet and computer generated radio and music that might be used in place of spoken voice. In this manner a call to an intercom might generate a return recorded audio signal such as “I am not available now”, or a remote command might be generated that requests the intercom to play real time content from a live source, including internet audio transmissions.

According to the illustrated embodiment, all connections between intercom pairs (as shown in FIGS. 1-3 and 5) rely on TCP/IP client-listener connections or incoming streams of data, in an unconnected mode, such as UDP broadcast data.

In the case of UDP broadcast data the intercom processor (600) will decode the packets in real time. This available data may be parsed to decode commands (Table 1) and Audio Packet information. In UDP reception the intercom data manager will not make a connection to the sender, only decode commands, act on said commands as needed, and process additional data such as programming mode packets or audio data streams.

In the case of TCP/IP connections, a connection request may be received by the TCP/IP manager (605) in a ‘stack’. The processor then checks to see if the intercom memory flag (618) has been set for listening on the requested port. If so, the stack replies to the remote peer, completing the connection. Once connected a flag is set in memory to steer the processor programming accordingly.

FIGS. 1, 2, 3 and 5 each outline modes to facilitate this connection process. They outline flexibility of the invention system, as connections may scale from a simple 2 intercom pair, to several operating without a PC server, or thousands operating with a central server. The common intercom design remains unchanged for all interconnections shown.

In each of the FIGS. 1-3 and 5 there is a connection on a Network (100) that may be a local LAN network, Internet (WAN) network, wireless network or combination of these networks over a large distance. The intercoms shown (101, 102; 201, 202 . . . 2nn; and 301, 302 and 303) all contain a unique identifier, normally a MAC ID, stored-in memory (618) and also contain an individual IP address and subnet mask in the commonly known format #.#.#.# (ex 192.168.0.100, 255.255.255.0) also stored in memory (618). These numbers may be assigned by the operator during a setup configuration (static IP) or may be assigned by the network on initialization (DHCP assignment).

FIG. 1 shows a paired configuration that intercom 101 would be set a as client and intercom 102 would be set as a listener via memory flag set in 618. On power up initialization the client (101) would have the client-listener mode set to client and assigned listener address pointing to the known IP address of Intercom 102, which has it's client-listener mode set to listener. Connection would occur when the listener 102, receive and accepts the clients request. Once connected data transfer is available at any time and voice communication may engaged by simply depressing the as the talk button (614). Connection is held on permanently, or until power loss or network failure.

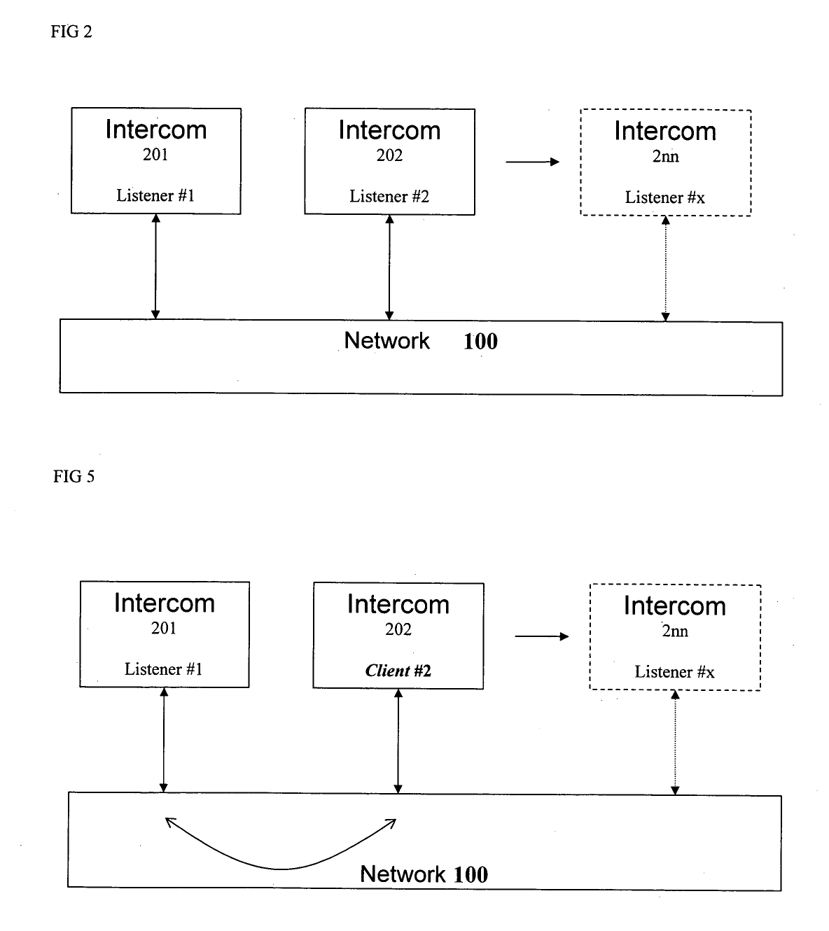

FIGS. 2 and 5 show a multi-connection configuration whereby an intercom array is available for multiple, paired communications expanded over a plurality of intercoms. Intercoms 201, 202, 2nn would all idle with the client-listener mode all set to listener. In the idle mode all intercoms would maintain a state waiting for a connect request from a client.

Each intercom may then have one or more “Talk” buttons; each “Talk” button associated with a known IP address in the intercom array. In this method a persons depression of the Talk Button (Intercom 202) would configure the intercom to immediately change the state of the client-listener mode from listener to a client, and further assign the listener IP address to the desired destination IP (such as 201), thereby enabling the sequence shown in FIG. 1, and specifically shown in FIG. 5. A timeout restoring the idle mode, after a period of time following release of the talk switch, would restore the idle mode in the client unit thereby transitioning the client back to listener mode.

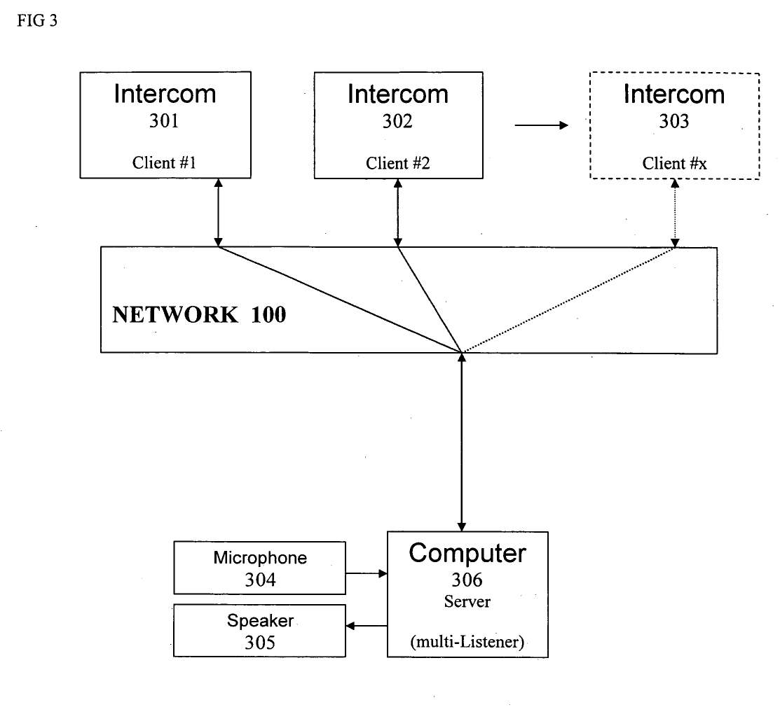

A multi-intercom array is shown in FIG. 3 whereby a plurality of intercoms, each in client mode might individually contact and connect with a single ‘listener’ server computer. Such an array could extend into the thousands of units, limited only by the server's capabilities to create and handle the expanding listener connection instances in memory.

FIG. 3 shows Intercoms 301 and 302, with the last intercom of an array indicated by (303). A single server (306) is shown that incorporates a standard multimedia support; microphone (304) and speaker 305). The server 306 may be implemented on a PC or other suitable server system. On power-up or network connection initialization, each intercom would attempt a connection to the same, known, pre-assigned server IP listener address and port. Each intercom would wait for the server (306) to accept the connection request. The server, by creating multiple instances of listeners, using Windows Winsock or similar program, would then be able communicate individually to any intercom via the multi-tasking software.

In the event that a client intercom (ex: 301) may not be able to establish a connection with the server (306) the client could advantageously attempt a connection to another listener according to a pre-programmed or interactive protocol, programmed in its fail-forward memory array.

Processor 600 contains coded internal programming routines to manage data, control intercom operation, process audio and remotely control distant intercoms.

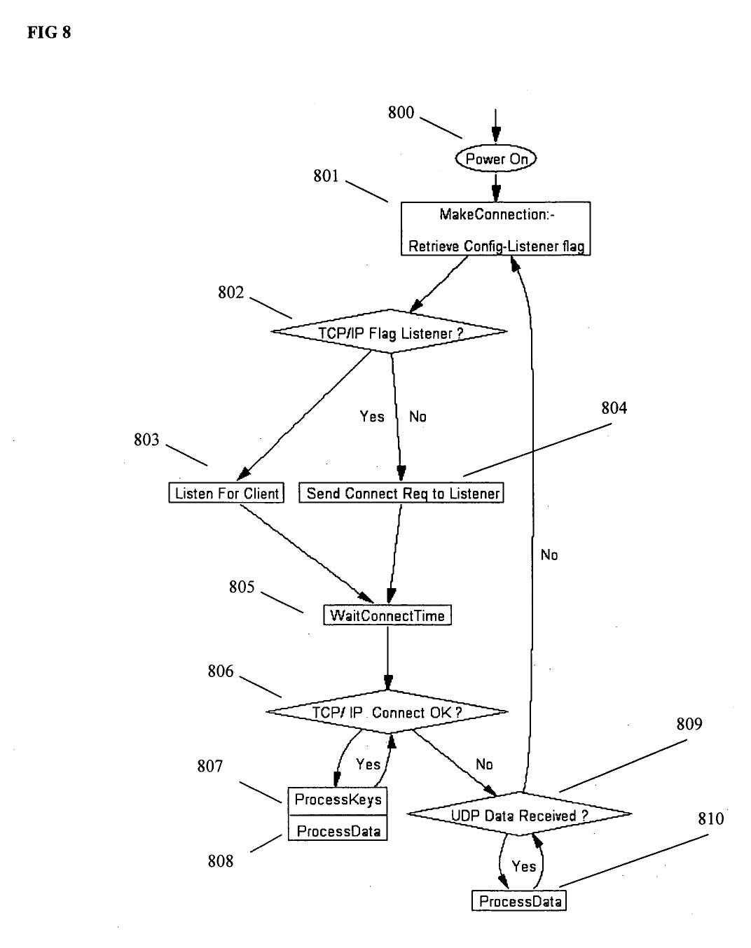

As shown in FIG. 8, system operation begins at Power-On (800) whereby the processor reads internal memory, then sets internal flags and sets status accordingly, including the network connection mode (801). The examination of network protocol and connection checks begins in a loop based on the client-listener mode flag shown in memory map (618).

If the Intercom is set as listener (803) the request comes into a network stack from another intercom and the program responds by accepting the connection (806). If the Intercom is set as a Client (804) the client sends repeated requests. Following a period of time (805), known TCP/IP protocol handshaking will result in a link acceptance indicating a completed connection.

Prior to loop cycling to 801, the Protocol and Data Manager (605) will check and read any incoming UDP packet (809). If the packets are decoded and indicate an instruction, the processor will process said instruction (810), or otherwise continue to wait for a TCP/IP connect by looping to 801. UDP data packets may advantageously include a unique identifier (ex: MAC Address) providing the ability for a specific intercom to validate the parsed packet as individually directed for processing, such as a configuration instruction, or directed to an intercom group, or processed as a system wide command, such as a paging audio stream.

If a connection is detected at (806) the subroutines ProcessKeys (807) and ProcessData (808) will be executed, each returning to the call point.

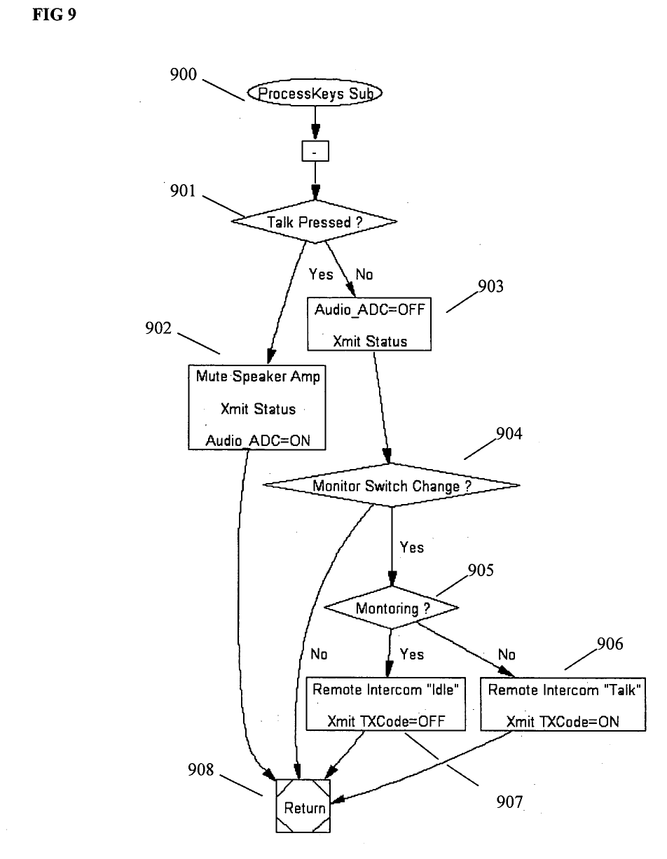

The Process Keys (807) routine is shown in FIG. 9 and begins at 900 to perform user interface testing for key-presses, and other external events. Of specific interest is the depression of the Talk Button (901), indicating the desire of the operator to speak. As outlined in FIG. 7A, the Half Duplex manager may, upon depression, mute the speaker to minimize acoustic feedback, enable the Codec Analog to Digital Conversion process, send a status command preceding the packet and send the audio packets in a TCP/IP flow controlled stream to the remote intercom (902). On release of the Talk Key Audio transmission would be terminated (903). In multi-connect arrangements (FIGS. 2 and 5) a plurality of Talk Keys (406), or keystroke sequences, may each establish a timed connection pair to a designated listener and subsequently execute the Talk audio mode as described in FIG. 2 detail.

Additionally outlined in 904 is the looping examination of an optional switch, Monitor, (904) employed to enable remote monitoring of audio. In the case of a depression the Monitor Mode (905) would toggle states, and additionally transmit codes instructing the distant intercom to Enable (906) and Disable (907) audio transmission back to the local intercom.

A return to the main loop at the point of the call occurs at the routine conclusion (908).

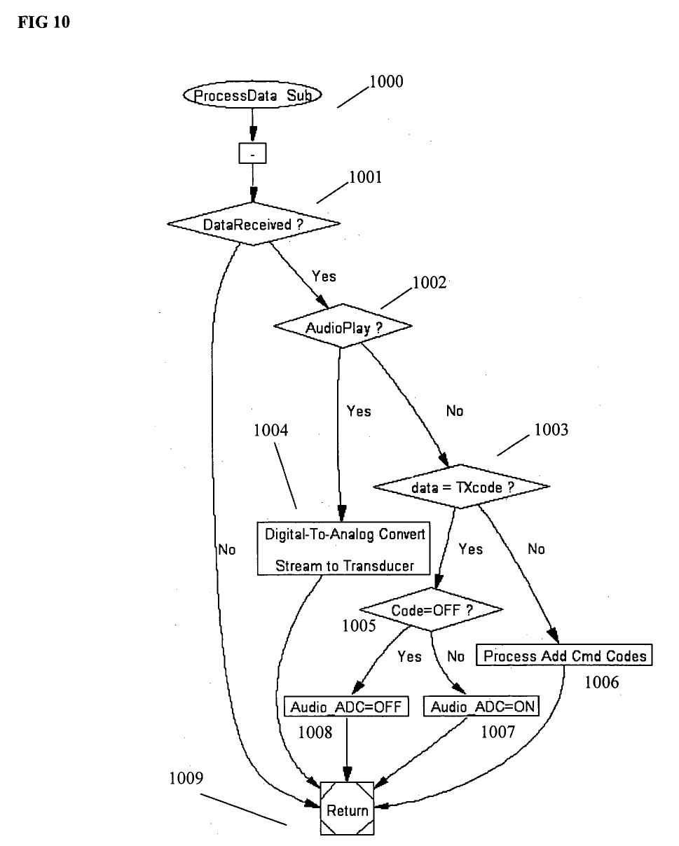

FIG. 10 shows an example of a ProcessData subroutine referred to in 808 and 810), whereby incoming data, both TCP/IP and UDP broadcasts are parsed for operational commands and data stream post-processing. If data is received (1000) it is processed, otherwise the routine returns to the main loop at the point of the call (1009).

When data is received a flag is tested to determine the state of local audio playback, such as the speaker audio in the active state (AudioPlay). The AudioPlay mode is examined by means of testing the memory for a previously received specific command code shown in Table 1. If AudioPlay is enabled (1002) then incoming data is treated as additional encoded audio data and at 1004, is moved the Codec data manager (609) and the subroutine returns 1004 to the main loop. Data received while AudioPlay is not enabled (1002) is further examined for a transmit code (TXcode) at 1003. If there is no TXcode the system will process any command codes at (1006) and return to the main loop at 1009. As previously mentioned, codes transmitted from distant intercoms may advantageously enable another intercom to engage transmission. In the event a command TXcode (1003) is detected, the code will be tested for an ON/OFF state at (1005), engaging the Audio_DAC (Digital to Analog Converter) at 1007 if the Code indicates ON, transmitting digital audio, as if the talk button had been physically depressed. If the Code indicates OFF at test 1005 Audio_DAC is disengaged at 1008.

A return to the main loop at the point of the call occurs at the routine conclusion (909).

1. An audio communication device comprising;
a processor and associated memory;
a codec connected to said processor;
a TCP/IP operating system on said processor;
at least one audio transducer and audio circuit connected to said codec/processor;
a trigger connected to said processor wherein said processor is programmed to establish a TCP/IP network connection to another device in a single client-listener pair configuration and is responsive to said trigger to enable a digitized audio transmission.

2. An audio communication device according to claim 1 wherein said processor includes program instructions to terminate the network connection a predetermined time period after release of said trigger.

3. An audio communication device according to claim 1 wherein said processor includes program instructions to establish said TCP/IP connection without Session Initiation Protocol (SIP) or exchange of SIP messages.

4. An audio communication device according to claim 1 configured for half duplex operation.

5. An audio communication device according to claim 1 further comprising a local audio switching circuit responsive to said processor.

6. An audio communication device according to claim 5 wherein the processor includes program instructions to cause the local audio switching circuit to stop audio transmission during audio reception.

7. An audio communication device according to claim 5 wherein the processor includes program instructions to cause the local audio switching circuit to reduce local audio output levels during audio transmission.

8. An audio communication device according to claim 1 wherein said trigger is a switch and said processor includes program instructions to monitor said switch and operates as a push to talk sequence.

9. An audio communication device according to claim 1 wherein said trigger is a remote command received by said processor.

10. An audio communication device according to claim 1 wherein said trigger is program instructions monitoring audio levels.

11. An audio communication device according to claim 9 wherein said trigger is activated upon monitoring in audio level greater than a threshold level.

12. An audio communication device according to claim 9 wherein said trigger is activated upon monitoring a level of inactivity.

13. An audio communication device according to claim 1 wherein said trigger is a timed event

14. An audio communication device according to claim 1 wherein said processor and codec are configured for uncompressed audio exchanges.

15. An audio communication device according to claim 1 wherein said processor and codec are configured for compressed and decompressed audio exchanges.

16. An audio communication device according to claim 1 wherein said audio transducer is a speaker for audio input and audio output.

17. An audio communication device according to claim 1 wherein said audio transducer is a tone transducer.

18. An audio communication device according to claim 1 wherein said trigger is a binary trigger.

19. An audio communication device according to claim 1 wherein said trigger is a digital signal from a processor.

20. An audio communication device according to claim 1 wherein said TCP/IP connection does not require DNS enabled address lookup, or H.323 protocol.

21. An audio communication device according to claim 1 wherein said processor is a personal computer.

22. An audio communication device according to claim 1 wherein said TCP/IP connection is a connection across a wide area network.

23. An audio communication device according to claim 1 wherein said TCP/IP connection is a connection across a local area network.

24. An audio communication device according to claim 1 wherein said TCP/IP connection is a connection across a wireless network.

25. An audio communication device according to claim 1 wherein said device has a fixed IP address.

26. An audio communication device according to claim 1 wherein said device has a DHCP assigned IP address.

27. An audio communication method comprising the steps of:
establishing a TCP/IP client server connection, upon power up, between an audio communication terminal and a remote device on the basis of an address stored in non-volatile memory of said audio communication terminal;
monitoring said connection for data addressed to said audio communication terminal;
converting data addressed to said audio communication terminal to audio output;
converting audio input to data addressed to said remote device; and
transmitting said data addressed to said remote device over said connection.

28. A method according to claim 27 wherein said address is an IP address of said remote device.

29. A method according to claim 27 wherein said address is a MAC address of said remote device.

30. A method according to claim 27 wherein said address is an address of a device containing an address of said remote device.

31. A method according to claim 30 wherein said device contains an address for an alternative remote device.

32. A method according to claim 27 wherein the step of establishing a TCP/IP client server connection comprises the steps of:
attempting to establish a connection to a remote device;
in the event that the audio communication terminal is unable to establish such connection, establishing a connection to a remote device located at an alternate address.

33. A method according to claim 27 further comprising the step of generating a tone at at least one terminus of said audio output.
